(19) United States
(12) Patent Application Publication
(10) Pub. No.: US 2021/0073931 A1
(43) Pub. Date: Mar. 11, 2021

(54) METHODS AND SYSTEMS OF ONLINE DISPUTE RESOLUTION TOOLS

(71) Applicants: Scott Seidewitz, las vegas, NV (US); Michael Greenzeiger, sunnyvale, CA (US); Linnea Bredenberg, sunyvale, CA (US)

(72) Inventors: Scott Seidewitz, las vegas, NV (US); Michael Greenzeiger, sunnyvale, CA (US); Linnea Bredenberg, sunyvale, CA (US)

(21) Appl. No.: 16/932,694

(22) Filed: Jul. 17, 2020

Related U.S. Application Data
(60) Provisional application No. 62/875,164, filed on Jul. 17, 2019.

(51) Int. Cl. G06Q 50/18; G06N 20/00

(52) U.S. Cl. CPC G06Q 50/182; G06N 20/00; G06Q 50/188

(57) ABSTRACT

A method for implementing online dispute resolution includes the step of, with a web service, providing in an online dispute resolution service. The online dispute resolution service communicates an online interface to each party in a dispute. The method includes the step of determining a set of dispute issues. The method includes the step of enabling each party in the dispute to utilize a set of online dispute resolution tools accessible through the web service to resolve a specified set of dispute issues. The method includes the step of providing a conflict resolution strategy to attempt until all eligible strategies are exhausted. Each conflict resolution strategy is presented to each party via a web page served by the web service.

### CLAIM OF PRIORITY AND INCORPORATION BY REFERENCE

This application claims priority from U.S. Provisional Application No. 62/875,164, filed 17 Jul. 2019. This application is hereby incorporated by reference in its entirety for all purposes.

### FIELD OF THE INVENTION

The invention is in the field of machine learning and system optimization and more specifically to a method, system and apparatus for online dispute resolution tools.

### 2. RELATED ART

One of the most difficult tasks for couples undergoing a divorce is reaching agreement on how to settle both monetary matters (e.g. property, spousal support, etc.) and non-monetary matters (e.g. custody, visitation, etc.). While online conflict resolution algorithms exist today, these focus primarily on monetary disputes and are not suitable for use in non-monetary and/or partially non-monetary disputes. Accordingly, there is a need for a system to allow combined monetary and non-monetary dispute resolution for couples undergoing divorce.

### SUMMARY OF THE INVENTION

A method for implementing online dispute resolution includes the step of, with a web service, providing in an online dispute resolution service. The online dispute resolution service communicates an online interface to each party in a dispute. The method includes the step of determining a set of dispute issues. The method includes the step of enabling each party in the dispute to utilize a set of online dispute resolution tools accessible through the web service to resolve a specified set of dispute issues. The method includes the step of providing a conflict resolution strategy to attempt until all eligible strategies are exhausted. Each conflict resolution strategy is presented to each party via a web page served by the web service.

### BRIEF DESCRIPTION OF THE DRAWINGS

FIG. 1 illustrates an example system for online dispute resolution, according to some embodiments.

FIG. 2 illustrates an example system for online resolution, according to some embodiments.

FIGS. 3-19 provide a series of screens that implement process 100 and system 200, according to some embodiments.

FIG. 20 depicts an exemplary computing system that can be configured to perform any one of the processes provided herein.

The Figures described above are a representative set and are not exhaustive with respect to embodying the invention.

### DESCRIPTION

Disclosed are a system, method, and article of online dispute resolution tools. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Machine learning (ML) can use statistical techniques to give computers the ability to learn and progressively improve performance on a specific task with data, without being explicitly programmed. Deep learning is a family of machine learning methods based on learning data representations. Learning can be supervised, semi-supervised or unsupervised. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Web service can be a service offered by an electronic device to another electronic device, communicating with each other via the World Wide Web. A web service can be a server running on a computer device, listening for requests at a particular port over a network, serving web documents (e.g. HTML, JSON, XML, images), and creating web applications services, which serve in solving specific domain problems over the Web (e.g. WWW, Internet, HTTP).

Example Methods

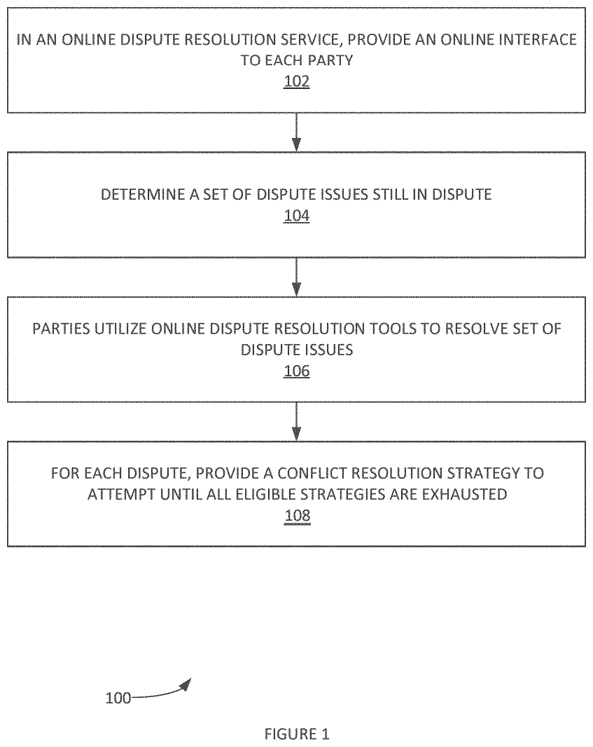

FIG. 1 illustrates an example system 100 for online dispute resolution, according to some embodiments. In step 102, process 100 can in an online dispute resolution service, provide an online interface to each party. For example, a couple undergoing divorce can use an online interface to each separately enter their preferred settlement for all of the different questions relevant to their particular case. For example, some couples may need to decide on the disposition of a marital home or on custody and visitation for minor children.

In step 104, process 100 can determine a set of dispute issues still in dispute. For example, all the dispute issues which the couple already agrees on are noted and can be set aside. In this way, the online dispute resolution tools can focus on those issues which still remain in dispute.

In step 106, process 100 can enable parties to utilize online dispute resolution tools to resolve set of dispute issues. Returning to the above example, the couple utilizes the online dispute resolution tools to resolve their disagreements. A set of dispute resolution tools can be offered in a specific order. It is noted that various machine learning and/or ranking tools can be used to select and/or order the dispute resolution tools. In this way, specific tools can be prescribed based on the particular circumstances of the couple. Based on their circumstances, the dispute resolution tools/strategies can be ranked by how successful they have been with similar couples (e.g. success rate for strategy used by couple with same demographic characteristics, etc.). The couple can also select between multiple tools by agreeing on one or agreeing to a randomly selected tool.

In step 108, process 100 can, for each dispute, provide a conflict resolution strategy to attempt until all eligible strategies are exhausted. If a conflict resolution strategy fails to provide a satisfactory result, the next strategy on the list is selected until all eligible strategies are exhausted. If a conflict resolution strategy fails to provide a satisfactory result, the next dispute on the list is selected until all eligible strategies are exhausted. If no settlement can be reached via one of the strategies, the case can be referred to a human mediator to address issues that have not been resolved.

Example Online Dispute Resolution Tools

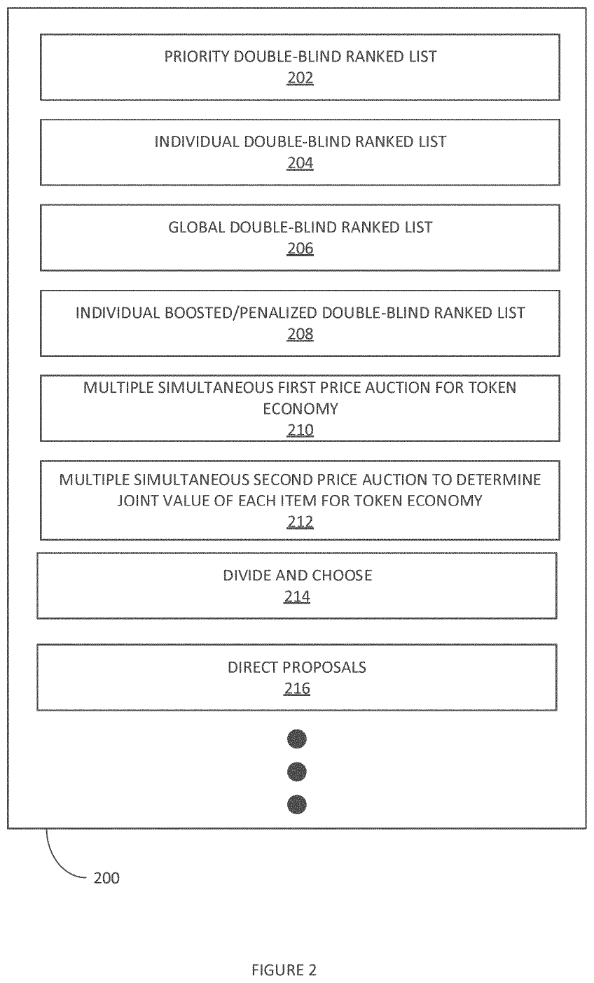

FIG. 2 illustrates an example system 200 for online resolution, according to some embodiments. System 200 can include a priority double-blind ranked list tool 202. Priority double-blind ranked list tool 202 can be utilized as follows. Each spouse ranks the overall settlement questions in terms of their priority. For example, a spouse can rank custody first, the marital home second, etc. Priority double-blind ranked list tool 202 can identify the items with the greatest difference in importance between the two spouses (e.g. one spouse rated high in importance and the other rated low in importance, etc.). Items that exceed a threshold in difference in importance (e.g. at least two positions different in ranking) can be shown to both spouses as possible compromises. Spouses can be encouraged to make offers from the list of items, which they will be able to do through the online system. When a spouse makes an offer, the other is given the opportunity to accept, refuse, or provide a counteroffer. The process continues until both spouses are done making offers and/or until all outstanding settlement questions are resolved. If no agreement is reached then the matter remains in dispute and another strategy may be attempted.

System 200 can include an individual double-blind ranked list tool 204. Individual double-blind ranked list tool 204 can be implemented as follows. For settlement questions in dispute in which there are multiple options, each spouse ranks the possible settlement options in order of their preference from most preferred (rank 1) to least preferred (rank n). Rankings from the two lists can be summed and the solution with the lowest joint rank is proposed. In the case of a tie between two options, the one with the lowest absolute rank by one spouse is chosen. If a tie remains, one option is chosen randomly. The spouses can be provided the opportunity to accept or refuse the proposed resolution. Alternatively, both spouses may be encouraged to make offers from the list of best ranked solutions, which they will be able to do through the online system. When a spouse makes an offer, the other is given the opportunity to accept or refuse. If no agreement is reached then the matter remains in dispute and another strategy may be attempted.

System 200 can include a global double-blind ranked list tool 206. Global double-blind ranked list tool 206 can be implemented as follows. All the possible outcomes from all matters in dispute are pooled. Each spouse ranks the possible settlement items in order of their highest to lowest priority with the highest priority receiving rank 1 and so forth. In some examples, each spouse may only assign a rank to a limited number of settlement items (e.g. 1, 2, or 3) from each settlement question. In all cases, the spouses must each provide the same number of rankings for each question. The two lists are pooled and the item with the lowest joint rank for each of the settlement questions is proposed as the settlement for that question. The spouses are given the opportunity to accept or refuse the proposed resolution. Alternatively, both spouses may be encouraged to make offers from the list of best ranked solutions, which they will be able to do through the online system. When a spouse makes an offer, the other is given the opportunity to accept or refuse. If no agreement is reached then the matter remains in dispute and another strategy may be attempted.

System 200 can include an individual boosted/penalized double-blind ranked list tool 208. Individual boosted/penalized double-blind ranked list tool 208 can be implemented as follows. First, each spouse ranks the overall settlement questions in terms of their priority. Next, each spouse ranks the possible settlement items for each settlement question in preference order as in 204. In one example, when the joint ranks are computed for each settlement item, a boost or penalty is given to settlement items coming from a spouse's ranking of the overall question. For example, if a spouse chose custody as their top priority then their ranks for that question can be multiplied by 1 whereas if it was only their second choice it would be multiplied by 2. In addition to a simple linear multiplier (1,2,3) it is also possible to use a quadratic multiplier (1, 2, 4) or any other multiplier progression. The two lists are pooled for each settlement question and the item with the lowest joint rank for each of the settlement questions is proposed as the settlement for that question. The spouses are given the opportunity to accept or refuse each proposed resolution. If no agreement is reached then the matter remains in dispute and another strategy may be attempted.

System 200 can include a multiple simultaneous first price auction for token economy tool 210. The multiple simultaneous first price auction for token economy tool 210 can be implemented as follows. Each spouse is allocated an equal number of tokens (e.g. 100). For each settlement question in dispute, each spouse can bid as many tokens as they wish to on their preferred solution, so long as they do not exceed the total number of allocated tokens between all the settlement questions in dispute. Whichever spouse bid the most on each question receives their preferred settlement item added to the proposed overall settlement. Each spouse is queried as to whether they will accept the proposed compromise. If either spouse does not accept then the matter remains in dispute and another strategy may be attempted. If any items receive no bids or have bids from both spouses below a threshold, they may be settled by coin toss.

System 200 can include a multiple simultaneous second price auction to determine joint value of each item for token economy tool 212. Multiple simultaneous second price auction to determine joint value of each item for token economy tool 212 can be implemented as follows. Each spouse is allocated an equal number of tokens (e.g. 100). For each settlement question in dispute they may bid as many tokens as they wish to on their preferred solution, so long as they do not exceed the total number of allocated tokens between all the settlement questions in dispute. The “fair value” of each settlement question is determined by the lower price of the two bids on each auction. A series of possible solutions are generated in which the value allocated to each spouse is equal based on the prices determined by the auction. If any items receives no bids or have bids from both spouses below a threshold, they may be settled by coin toss. Each spouse is asked if they will accept any of the possible solutions and if so, to rank them in order of preference. If both spouses accept at least one solution jointly then the mutually accepted solution with the lowest joint rank is proposed. Each spouse is queried as to whether they will accept the proposed compromise. If either does not accept then the matter remains in dispute and another strategy may be attempted. In some implementations, the results from the first price auction in 210 can be used for the second price auction in 212.

System 200 can include a divide and choose tool 214. Divide and choose tool 214 tool can be implemented as follows. A spouse can be randomly selected to partition the settlement questions in dispute by whether “Spouse A” or “Spouse B” receives their preferred item for each one. The second spouse chooses whether they wish to be “Spouse A” or “Spouse B”. In some implementations, it may be desirable to run this multiple times and then have the spouses jointly rank which proposed solution is the best, taking the lowest joint rank.

System 20 can include a direct proposals tool 216. Direct proposals tool 216 can be implemented as follows. Both spouses may propose a trade of at least one question decided in accordance with their spouse's preference in return for at least one question decided in accordance with their own preference. Spouses can also alternatively propose one or more items to be decided based on a compromise solution which did not match the initial selection of either spouse. Spouses may optionally include a message to their spouse indicating the rationale for the proposed compromise. Textual analysis can be utilized to ensure that no inflammatory language is used by either spouse during messaging. When a spouse makes an offer, the other is given the opportunity to accept or refuse. If no agreement is reached then the matter remains in dispute and another strategy may be attempted.

It is noted that system 200 can be adapted for other types of dispute resolution between two or more parties.

Example User Interfaces

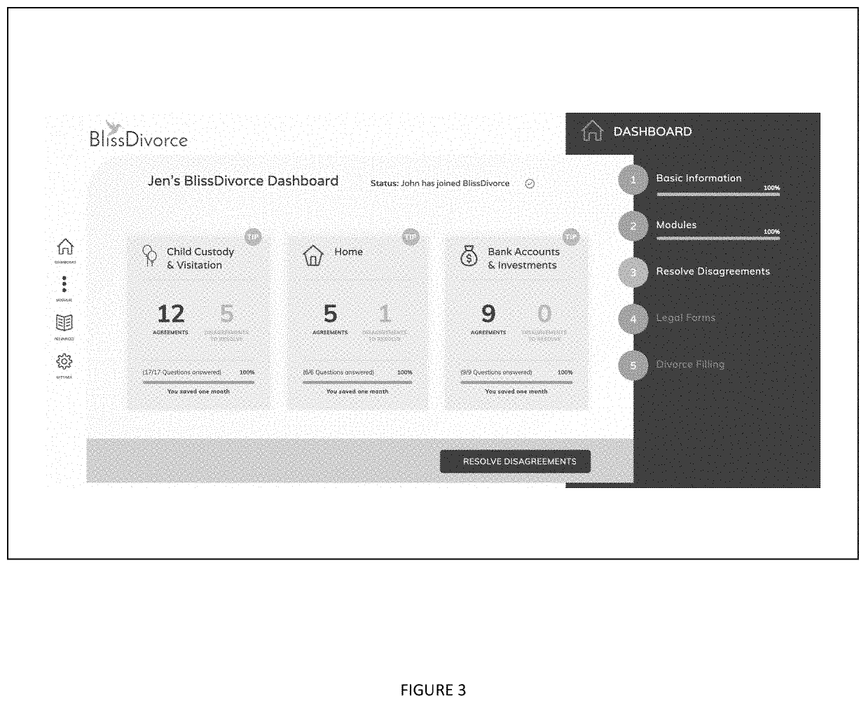

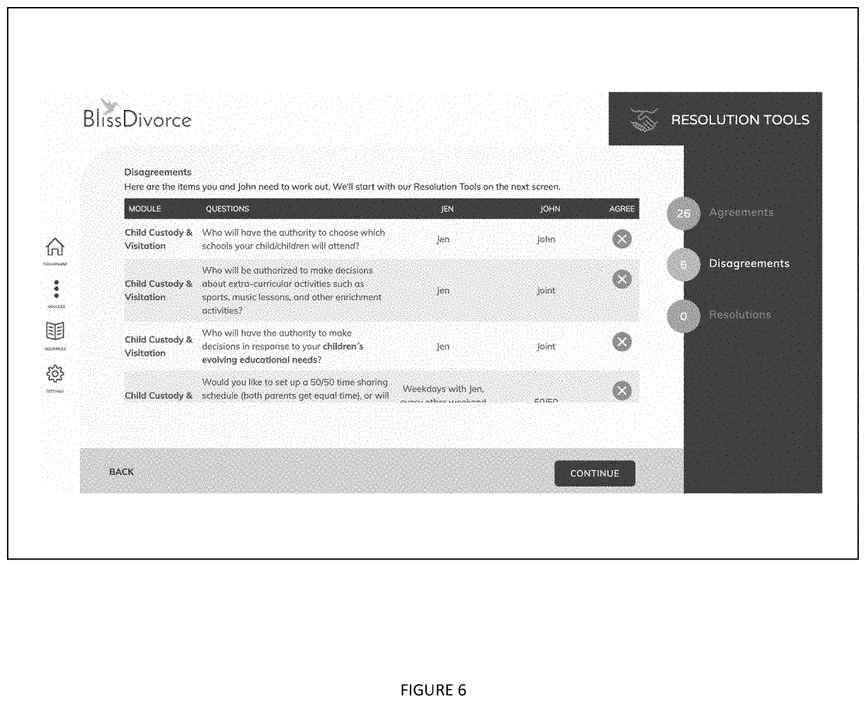

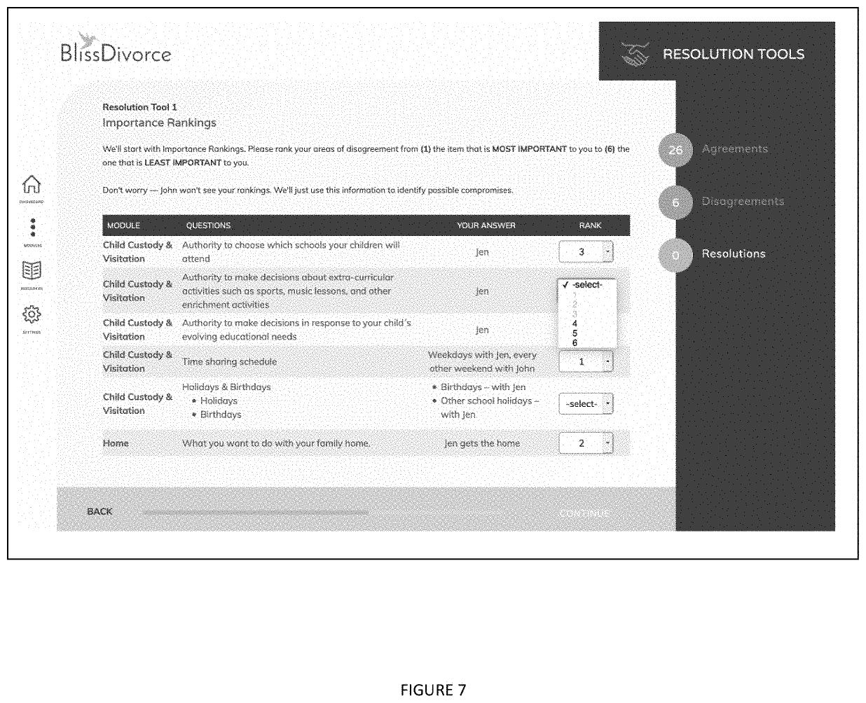

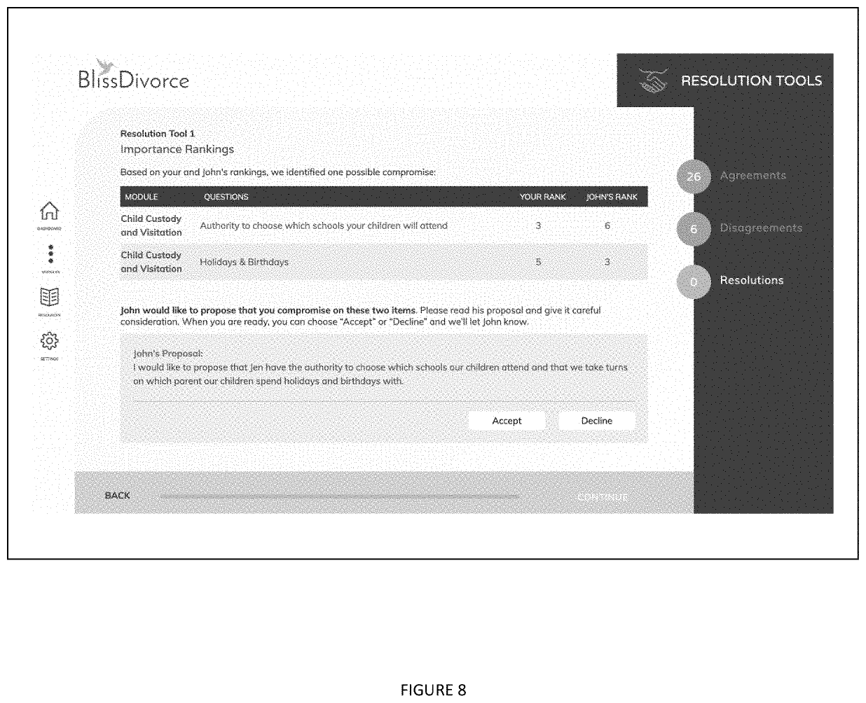

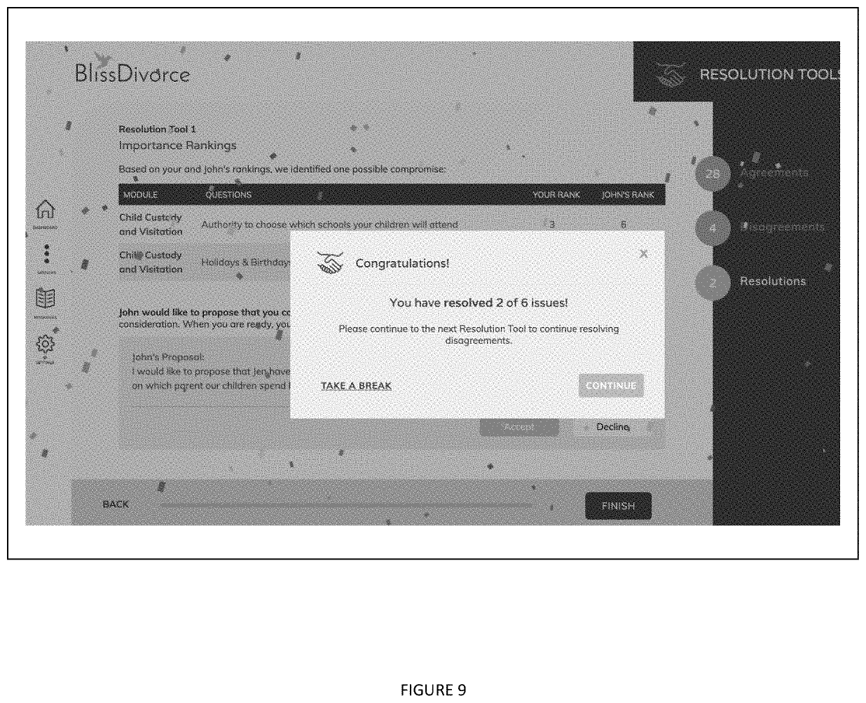

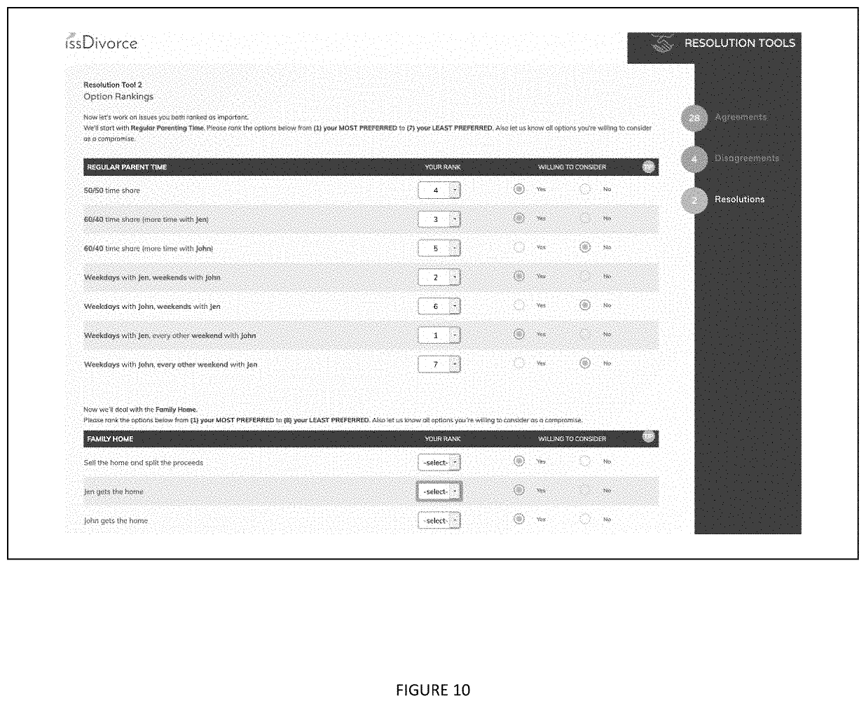

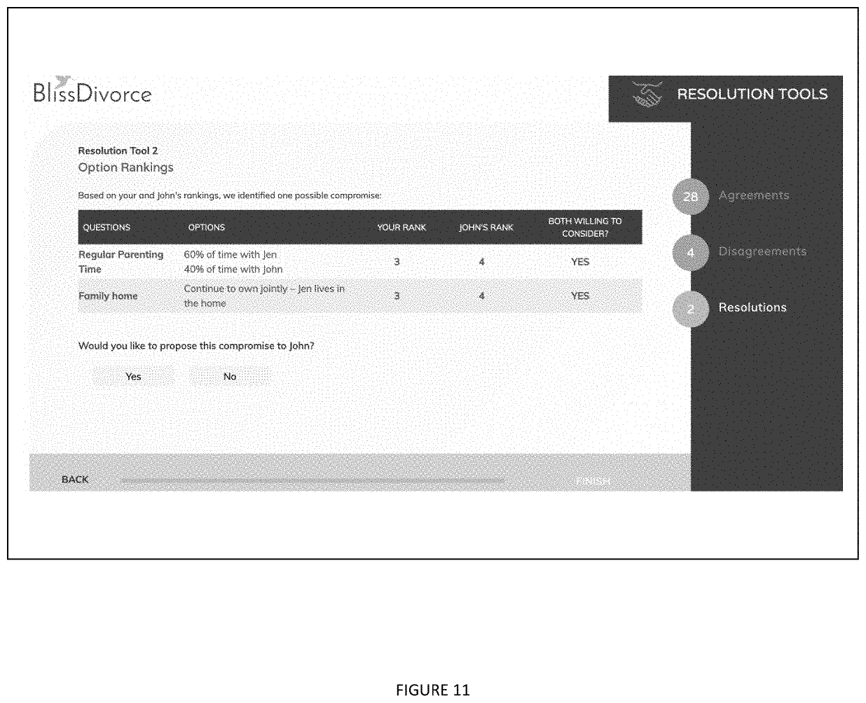

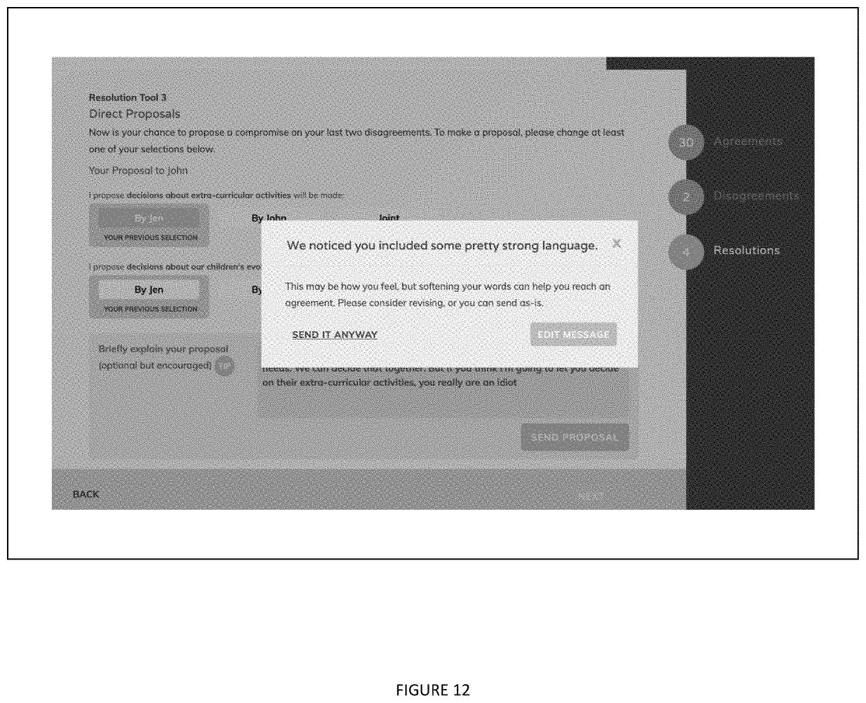

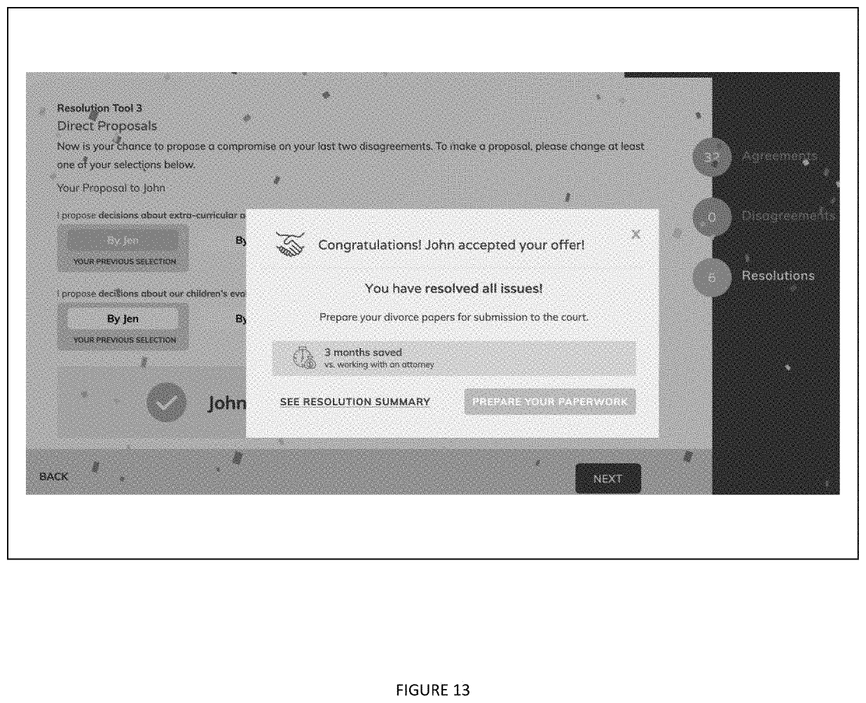

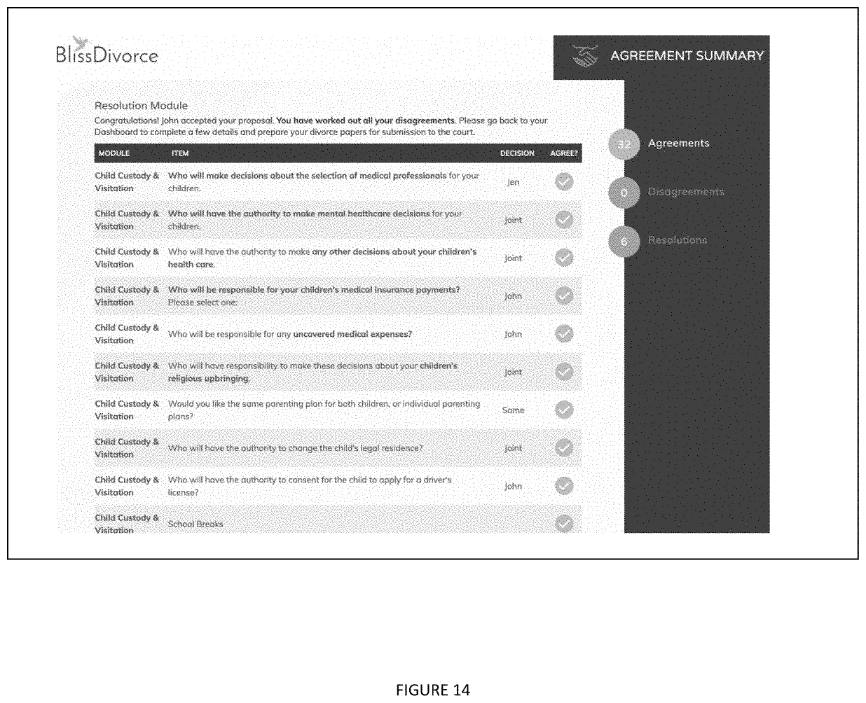

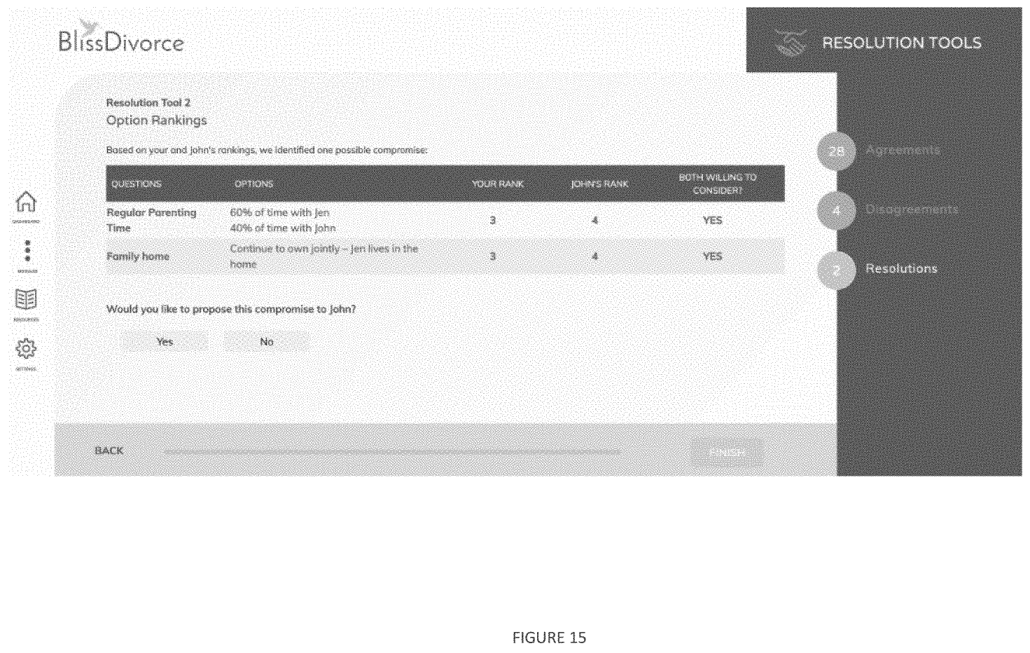

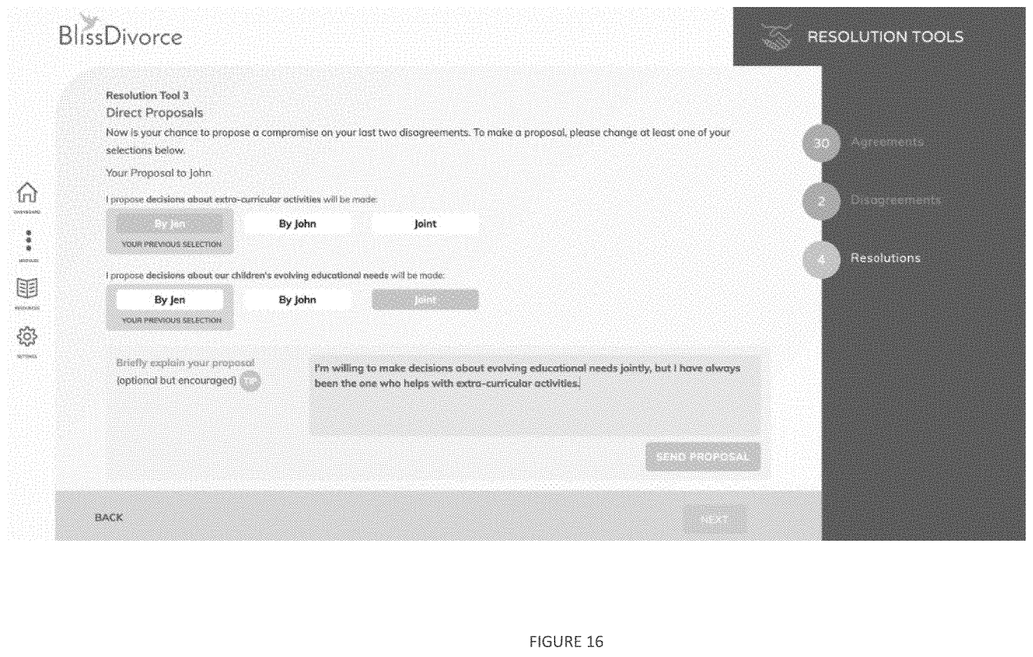

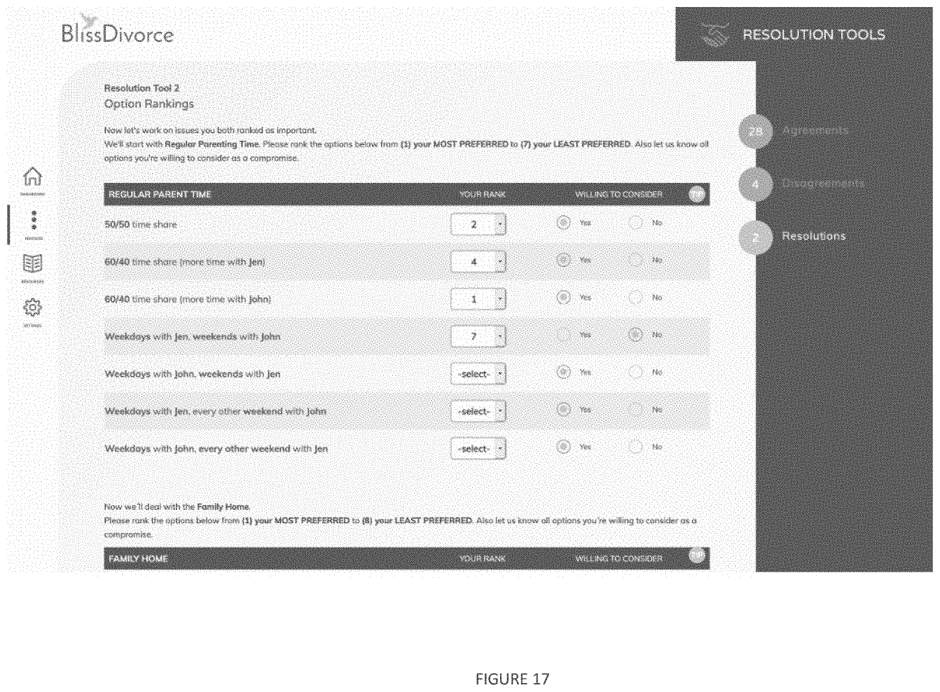

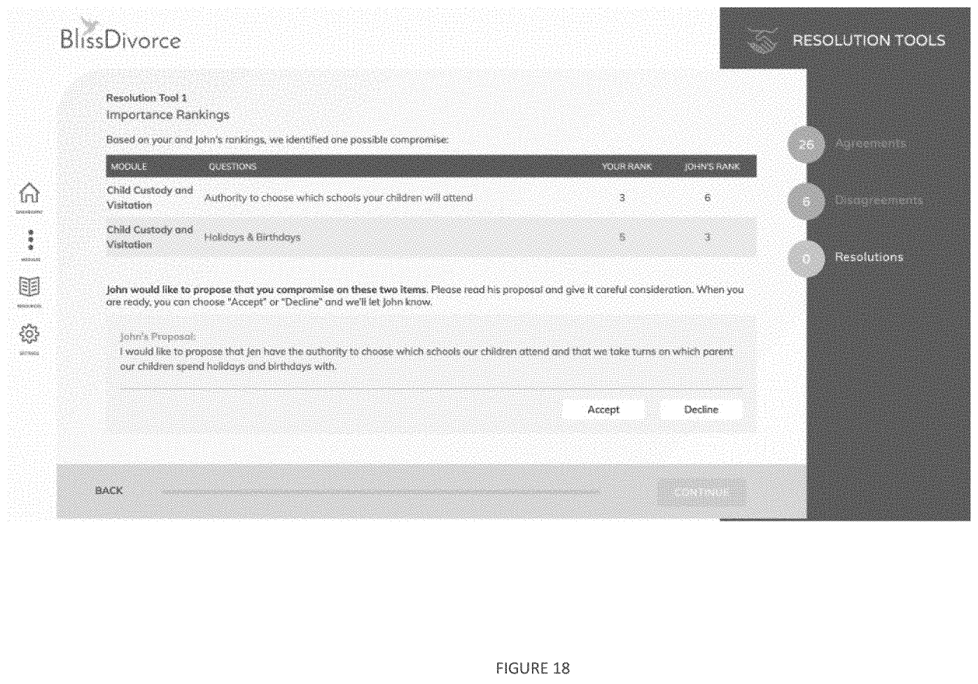

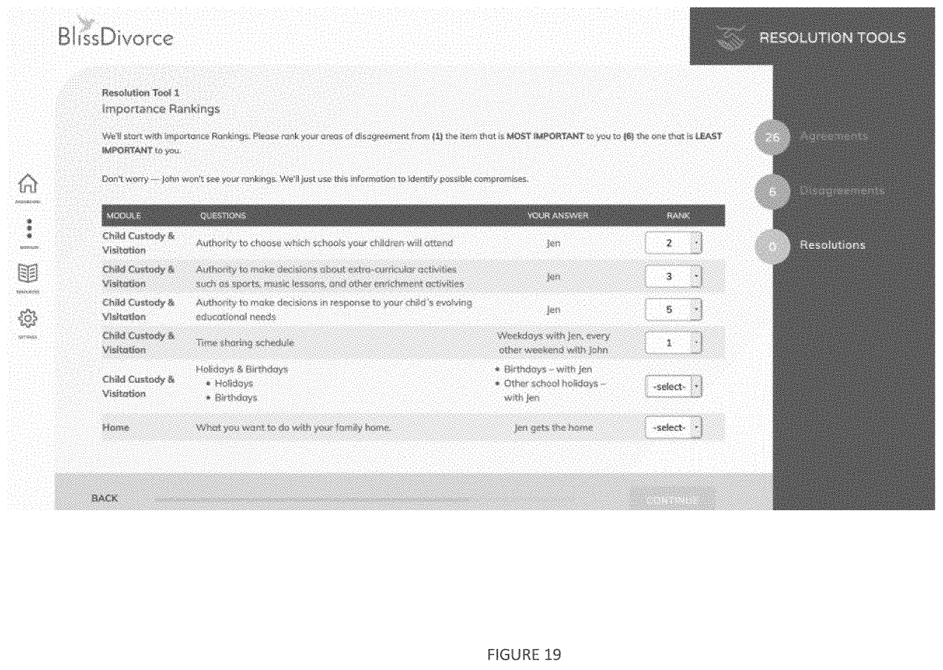

FIGS. 3-19 provide a series of screen shots that illustrate an implementation of process 100 and system 200, according to some embodiments. More specifically, FIGS. 3-19 illustrate a series of dispute resolution tools displayed to the users. User can provide answers via the computer interfaces. This information can be stored in a database. Various processes (e.g. process 100 and system 200) and machine learning algorithms can utilize this data. Outputs can be provided to users and/or a dispute resolution entity. The screen shots of FIGS. 3-19 can be provided via a web interface and/or mobile device applications.

It is noted that machine learning algorithms can optimize the content of the screen shots of FIGS. 3-19 based on preceding user inputs. User input data can be aggregated and used as training data sets for various optimization purposes as well.

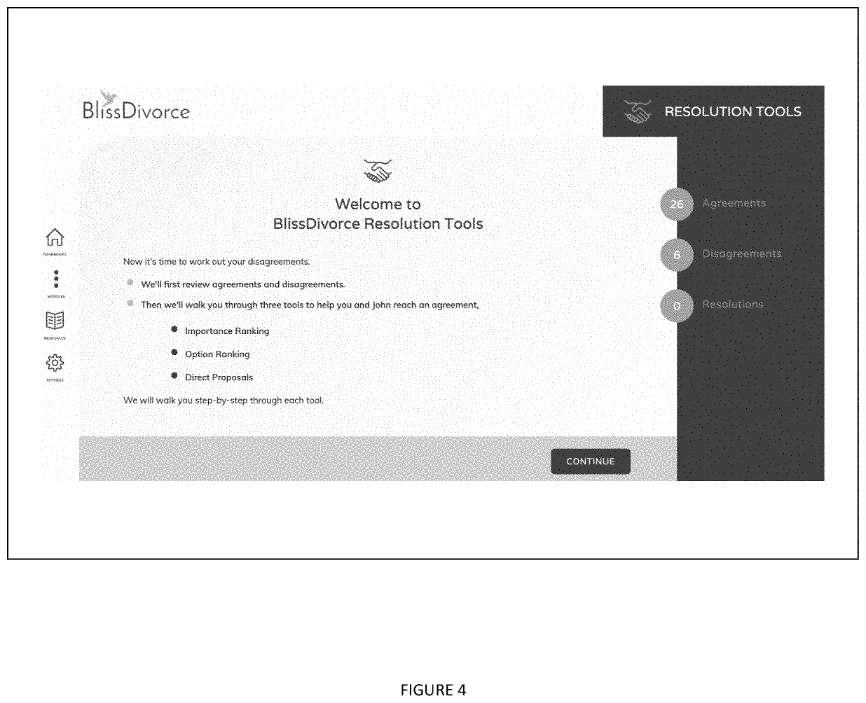

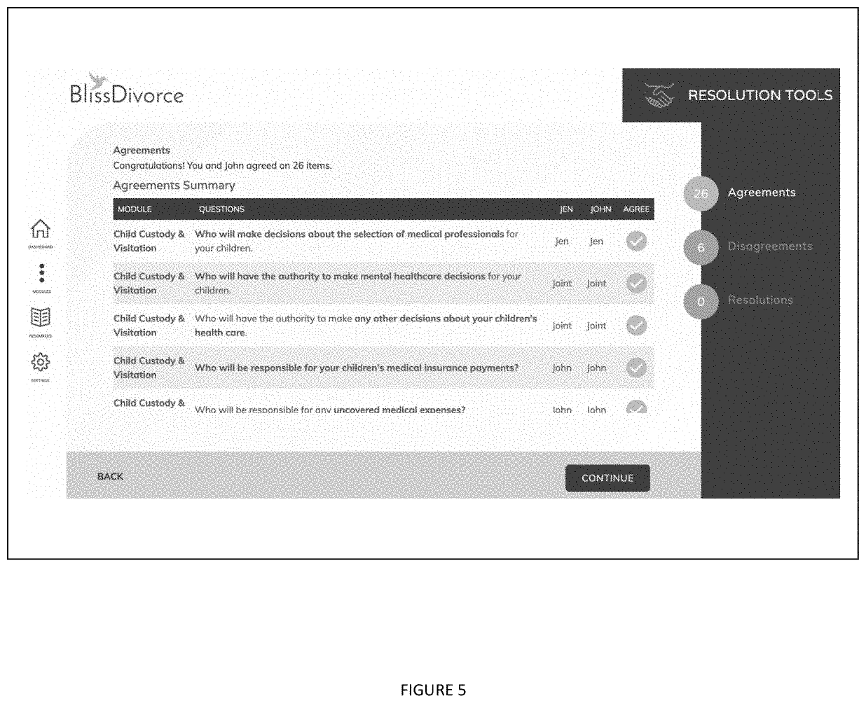

More specifically, FIG. 3 illustrates an initial screen shot showing areas of the dispute where the parties agree. FIG. 4 illustrate an example screen shot showing the areas of the dispute where the parties do not agree. Selected tools of system 200 are now applied as a resolution module in the screen shots of FIGS. 5-19. Each utilized tool can provide one or more screens to show users instructions/queries and obtain user information/responses.

Additional Computing Systems

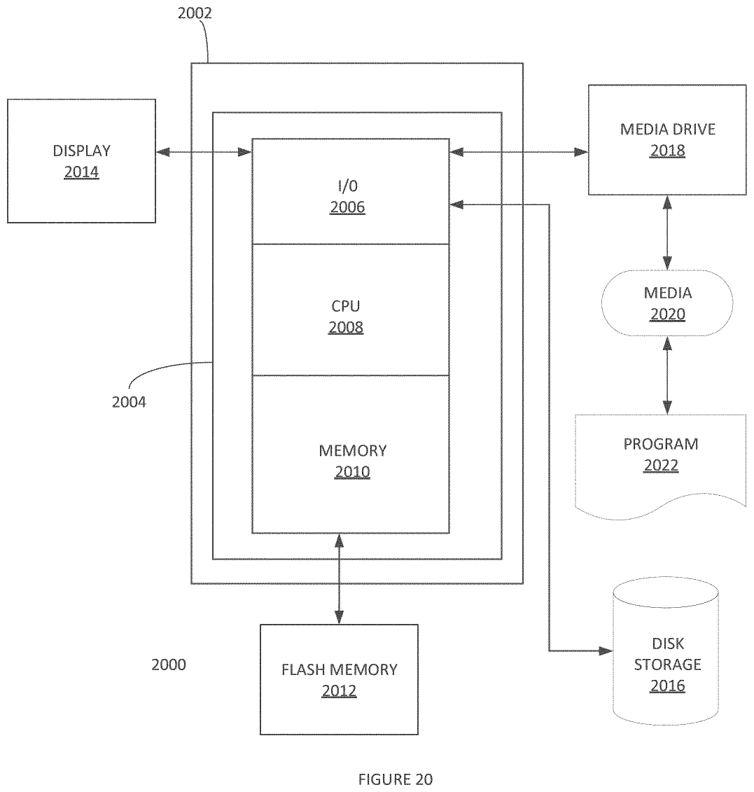

FIG. 20 depicts an exemplary computing system 2000 that can be configured to perform any one of the processes provided herein. In this context, computing system 2000 may include, for example, a processor; memory, storage, and I/O devices (e.g., monitor, keyboard, disk drive, Internet connection, etc.). However; computing system 2000 may include circuitry or other specialized hardware for carrying out some or all aspects of the processes. In some operational settings, computing system 2000 may be configured as a system that includes one or more units, each of which is configured to carry out some aspects of the processes either in software, hardware, or some combination thereof.

FIG. 20 depicts computing system 2000 with a number of components that may be used to perform any of the processes described herein. The main system 2002 includes a motherboard 2004 having an I/O section 2006, one or more central processing units (CPU) 2008, and a memory section 2010, which may have a flash memory card 2012 related to it. The I/O section 2006 can be connected to a display 2014, a keyboard and/or other user input (not shown), a disk storage unit 2016, and a media drive unit 2018. The media drive unit 2018 can read/write a computer-readable medium 2020, which can contain programs 2022 and/or data. Computing system 2000 can include a web browser. Moreover, it is noted that computing system 2000 can be configured to include additional systems in order to fulfill various functionalities. Computing system 2000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for implementing online dispute resolution, comprising the steps of:
with a web service, providing in an online dispute resolution service, wherein the online dispute resolution service communicates an online interface to each party in a dispute;
determining a set of dispute issues;
enabling each party in the dispute to utilize a set of online dispute resolution tools accessible through the web service to resolve a specified set of dispute issues; and
for each dispute, providing a conflict resolution strategy to attempt until all eligible strategies are exhausted, wherein each conflict resolution strategy is presented to each party via a web page served by the web service.

2. The method of claim 1 further comprising:
with the web service, serving a set of webpages to a couple undergoing a divorce, wherein the set of webpages are used by at least one web browser to generate an online interface to each partner of the couple separately such that each partner enters a preferred settlement for all of the different questions relevant to their particular case.

3. The method of claim 2, wherein each preferred settlement comprises a disposition preference of a marital home.

4. The method of claim 3, wherein each preferred settlement comprises a custody and visitation preference for a minor child.

5. The method of claim 4, wherein all the dispute issues which the couple has already agrees on are set aside such that the web server does not include web pages related to the agreed upon issues.

6. The method of claim 1, wherein the web server provides a set of dispute resolution tools are served each party.

7. The method of claim 6, wherein the set of dispute resolution tools are offered in a specific order.

8. The method of claim 7 further comprising:
using a specified machine learning algorithm and a ranking tool to the dispute resolution tool.

9. The method of claim 8, wherein the dispute resolution tool prescribed based on a particular circumstances of the couple.

10. The method of claim 9 wherein the dispute resolution tools are ranked by how successful they have been with a set of similar couples to the couple.

11. The method of claim 10, where the couple selects between multiple dispute resolution tools by agreeing on one or agreeing to a randomly selected dispute resolution tool.

12. The method of claim 11, wherein when a conflict resolution strategy fails to provide a satisfactory result, a next strategy on the list generated by the machine-learning algorithm is selected until all eligible strategies are exhausted.

13. A computerized system useful for implementing online dispute resolution comprising:
at least one processor configured to execute instructions;
at least one memory containing instructions when executed on the at least one processor, causes the at least one processor to perform operations that:
with a web service, provide in an online dispute resolution service, wherein the online dispute resolution service communicates an online interface to each party in a dispute;
determine a set of dispute issues;
enable each party in the dispute to utilize a set of online dispute resolution tools accessible through the web service to resolve a specified set of dispute issues; and
for each dispute, provide a conflict resolution strategy to attempt until all eligible strategies are exhausted, wherein each conflict resolution strategy is presented to each party via a web page served by the web service.
